(19) United States
(12) Patent Application Publication
(10) Pub. No.: US 2008/0155618 A1
(43) Pub. Date: Jun. 26, 2008

(54) System and method for managing multiple content sources

(76) Inventors: Steven Grady, Redwood City, CA (US); Erik Scheelke, Santa Clara, CA (US)

Correspondence Address: MORRISON & FOERSTER, LLP, 555 WEST FIFTH STREET, SUITE 3500, LOS ANGELES, CA, 90013-1024, US

(21) Appl. No.: 11/643,146

(22) Filed: Dec. 20, 2006

(51) Int. Cl. H04N 7/173

(52) U.S. Cl. 725/97

(57) ABSTRACT

The preferred embodiments of the present invention are directed to systems and methods for centralizing the scheduling of multiple tuners for recording content from various sources. In accordance with the preferred embodiment, a universal network tuner is created whereby the tuning capabilities of each networked device within a given geography (e.g., all of the consumer electronics and computers within a household) are aggregated at a central location from which a user may interact with a graphical user interface (“GUI”) to control, view, and schedule programming available to any any/all of the tuners within the system.

### BACKGROUND

1. Field of Invention

The present invention is directed to a system and method for scheduling the recording of content, such as television programming, from multiple sources (e.g., satellite receiving box, over-the-air antenna, Internet, etc.). The present invention also provides a method for resolving conflicts created by requests for content from limited resources.

2. Description of Related Art

Most consumer homes today have multiple consumer electronic devices capable of accessing and displaying multimedia content. For instance, a typical household may have a television in a common area such as the living room or the family room, a television in the master bedroom, a computer in either one of the bedrooms or the den. One or more of these display devices may also have attached a playback device such as a VCR or a DVD player.

Conventionally, a household television can receive content from programming providers via over the air broadcast (e.g., NBC, CBS, or ABC broadcast signals), cable content providers, or satellite content providers. Each of these sources of content provide programming (most of them at predetermine scheduled times), some of which are available free of charge, some of which are considered premium content and are available only upon payment of monthly subscription fees or one-time charges, and some of which may be delivered on demand by the consumer (i.e., pay per view). Some of the content signals may be received via digital signals, some received via analog signals. At the same time, certain televisions devices have over-the-air content tuning capabilities for receiving over-the-air broadcast signals (such as digital television broadcast signals) or even cable signals, while certain television devices require external tuning device (such as a satellite box) in order to display images from a digital signal (either over the air or satellite digital signals). In a typical household, it is common to have multiple display devices (e.g., television, personal computer, etc.) that have different display capabilities, different tuning capabilities, and access to different content.

A popular method of viewing content is via the time-shifting method. Until recently, VCRs were popular devices amongst consumers for recording content. VCRs typically required that the user set the time and channel of the content to be recorded. Although certain VCRs provided advanced programming capability for recording multiple shows or repeatedly recording shows at designated times of designated days, VCRs were still considered “blind” recording devices in that the recordings programming required a user to input time and date of the event; users of VCR devices would need to check television programming guide in order to program in the correct time and date for recording the desired show.

Recently, personal digital recording devices have become popular (e.g., digital video recorders, or DVRs). Service providers such as TiVo provide the ability to use program listing from a programming guide as graphical user interface (“GUI”) for selecting and recording a show. By using a programming guide to designate a show for recording, the user need not separately check listing times in order to program the DVR to record the show at the correct time and date. Additionally, an electronic programming guide (“EPG”) also allows users additional ease of searching for shows to be recorded. U.S. Patent Application Publication No. US2005/0022241, titled “Adaptable Programming Guide for Networked Devices,” and U.S. Patent Application Publication No. US2002/0053081, with the same title, both of which are hereby incorporated by reference, illustrate several examples of using an EPG to locate program listings.

At the same time, as modern homes become “wired” as many of the traditional consumer electronic devices become network enabled within the home, it is possible to access, from a single location within the home, content and media located at other locations of the home. U.S. Patent Application Publication Nos. US2002/0029384, titled “Mechanism for Distributing Content Data,” US2004/0255327, titled “Media Content Distribution System and Method,” and US2005/0022243, titled “Distributed Media Management Apparatus and Method,” each of which is hereby incorporated by reference, illustrate a variety of methods by which content from different sources may be aggregated and distributed within a home network.

However, along with more content availability and diverging hardware devices within the home, it is becoming increasingly time consuming for a user to keep track of which devices within the home is capable of receiving what type of content, and to program the appropriate device for recording desired content at the appropriate time. For instance, as shown in FIG. 1A, a user may have multiple display devices (e.g., televisions 170 and 172) that have different tuning and display capabilities, as well as different levels of content access to a particular satellite or cable providers. In such a situation, if a user wishes to record a particular show, he or she needs to remember which tuner is capable of receiving which type of shows, and to program the appropriate receiving device to record the show at the appropriate time. At the same time, the user needs to carefully choose his or her viewing device of choice so as to not cause any conflict with a device that is pre-occupied with the recording of a show in accordance with a previous recording program set by the user. Furthermore, as more and more devices within the home become network become enabled within the home, such as refrigerators, security cameras, and even personal cell phones, and as more and more content and media become available from these different sources, it is desirable to have a centralized management system by which a user may easily select for viewing and/or recording of such content, without having to worry about the schedule by which each desired content is available for recording or viewing, which of the locations have the proper hardware to view which type of content, etc.

### SUMMARY OF THE INVENTION

The preferred embodiments of the present invention are directed to systems and methods for centralizing the scheduling of multiple tuners for recording content from various sources. In accordance with the preferred embodiment, a universal network tuner is created whereby the tuning capabilities of each networked device within a given geography (e.g., all of the consumer electronics and computers within a household) are aggregated at a central location from which a user may interact with a graphical user interface (“GUI”) to control, view, and schedule programming available to any any/all of the tuners within the system.

In accordance with a preferred embodiment of the present invention, a centralized content management system includes a content management unit that is connected to tuners (e.g., terrestrial tuners, satellite receivers, DVD players, computers, digital cameras, camcorders, etc.) and presentation devices (e.g. television devices, computers, stereo receivers, etc.). The content management system detects the availability and status of all of the tuners on the system, retrieves one or more programming guide(s) that list content available to one or more of the tuners, and publishes a global schedule of all of the content retrievable via the aggregate of tuners.

The global schedule, which is preferable accessible by the user via a graphical user interface, may be used to set recording of programming, playback of content (either recorded by the system or pre-existing recorded content such as a DVD(, or live request of content (via tuning a tuner to a particular source, such as tuning to a television station, tuning to a radio station, etc.).

The system according to the preferred embodiment includes a scheduling kernel which receives and processes all of the users' requests, and, while assessing the system status, device and tuner capabilities, and any pre-existing requests, attempts to satisfy all of the user requests according to a pre-set order of priority. In situations where irreconcilable conflicts exists, the system may request the user to make a decision as to which requests may be ignored.

### BRIEF DESCRIPTIONS OF THE DRAWINGS

FIG. 1A is an illustration of an environment in which a centralized scheduling system in accordance with the preferred embodiment may be implemented;

FIG. 1B is a graphical illustration of a network by which a centralized scheduling system in accordance with the preferred embodiment may be implemented;

FIG. 2 is a schematic illustration of an overview of a centralized scheduling system in accordance with the preferred embodiment;

FIG. 3 is an expanded schematic illustration of the centralized scheduling system in accordance with the preferred embodiment;

FIG. 4A is a flow chart illustrating various steps of a method for centralizing the recording of content from various tuners in accordance with the preferred embodiment;

FIG. 4B is a flow chart illustrating additional steps of the method for centralizing the recording of content from various tuners in accordance with the preferred embodiment;

FIG. 5 is a schematic illustration of an aspect of the centralized scheduling system in accordance with the preferred embodiment;

FIG. 6 is a schematic illustration of another aspect of the centralized scheduling system in accordance with the preferred embodiment;

FIG. 7 is a schematic illustration of yet another aspect of the centralized scheduling system in accordance with the preferred embodiment;

FIG. 8 is a schematic illustration of yet another aspect of the centralized scheduling system in accordance with the preferred embodiment;

FIG. 9 is a schematic illustration of yet another aspect of the centralized scheduling system in accordance with the preferred embodiment;

FIG. 10 is a schematic illustration of yet another aspect of the centralized scheduling system in accordance with the preferred embodiment;

FIG. 11 is a schematic illustration of yet another aspect of the centralized scheduling system in accordance with the preferred embodiment;

FIG. 12 is an illustration of a screen shot from a graphical user interface of the centralized scheduling system in accordance with the preferred embodiment;

FIG. 13 is an illustration of another screen shot from a graphical user interface of the centralized scheduling system in accordance with the preferred embodiment;

FIG. 14 is an illustration of yet another screen shot from a graphical user interface of the centralized scheduling system in accordance with the preferred embodiment;

FIG. 15 is an illustration of yet another screen shot from a graphical user interface of the centralized scheduling system in accordance with the preferred embodiment; and

FIG. 16 is an illustration of yet another screen shot from a graphical user interface of the centralized scheduling system in accordance with the preferred embodiment;

### DETAILED DESCRIPTION OF THE PREFERRED EMBODIMENTS

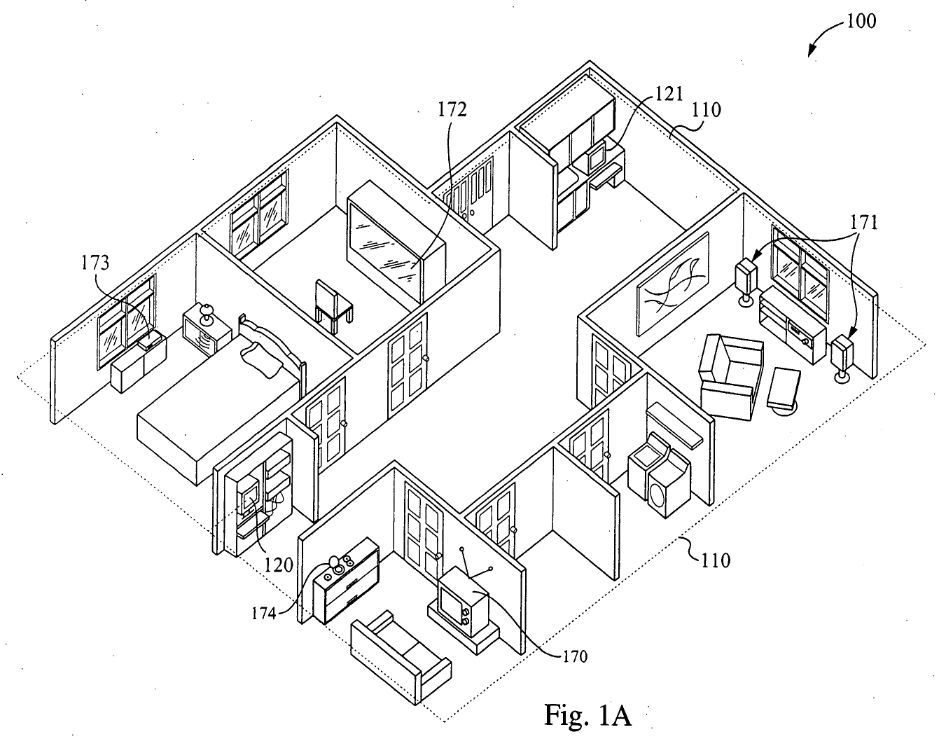

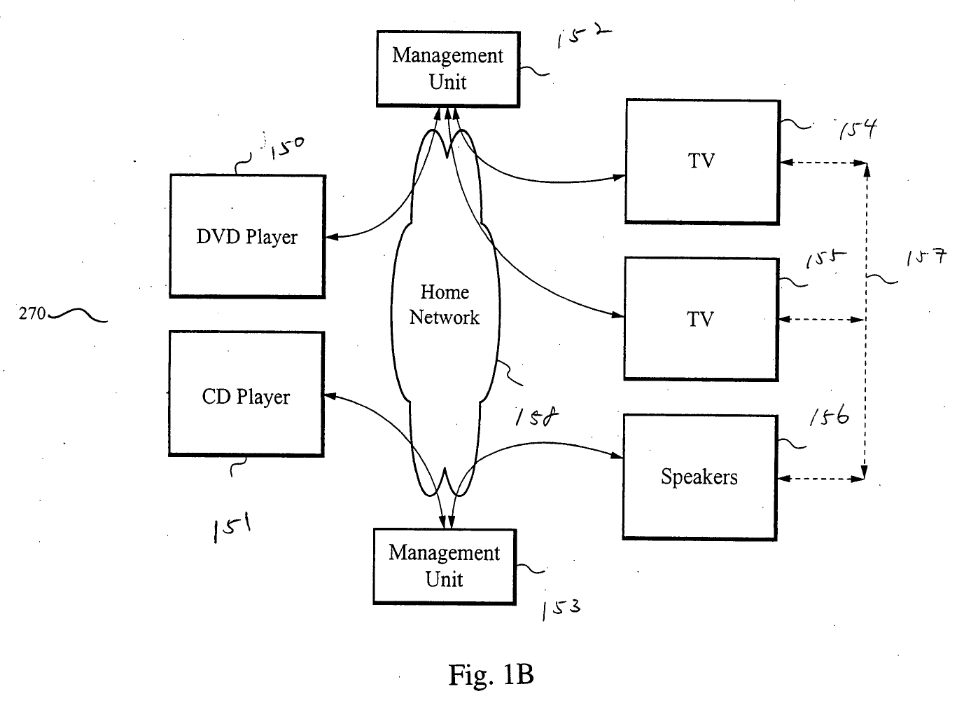

The preferred embodiments of the present invention will now be described with respect to FIGS. 1-16.

For purposes of this application, a “tuner” shall mean any device (including consumer electronic devices) that can receive or retrieve content media from one or more sources. Tuner may include, without limitation, single or multiple disc DVD, CD, or laser disc players, VCRs, satellite receivers, cable set top boxes, personal video recorders (PVR), radio receivers. The tuners may have access to more than one source of content; for instance, a set top box may have multiple tuner cards (i.e., asymmetric tuning capability) that can each access a channel independently of the other card.

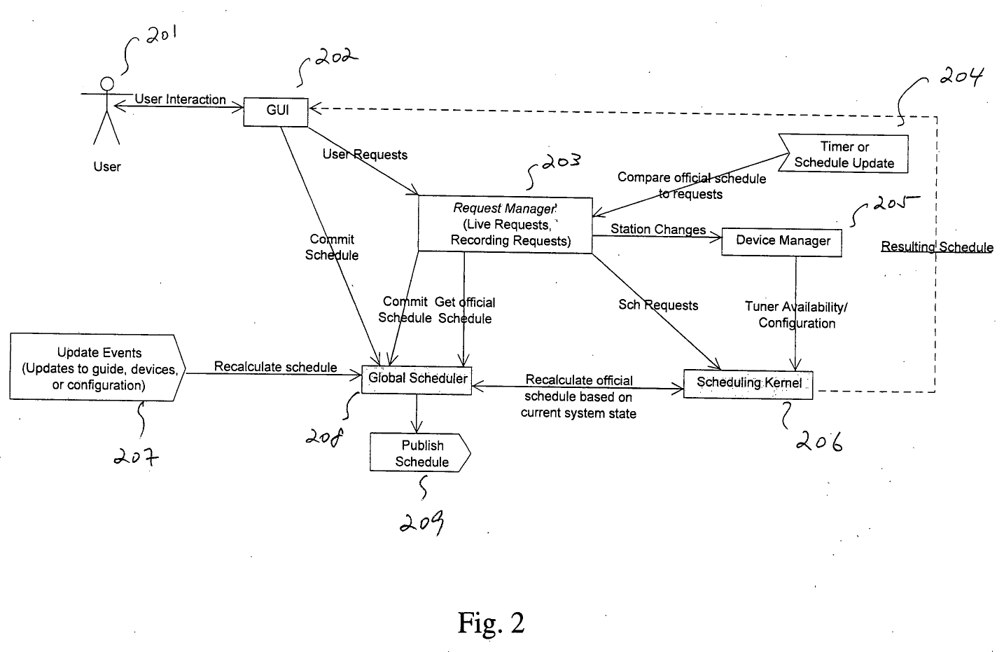

It is noted that the items illustrated in FIGS. 2, 3 and 5-11 are intended as illustrations of software modules, but they may also be realized as hardware (e.g., programmed processors).

FIG. 1A illustrates a typical household environment 100 within which the preferred embodiment of the present invention may be deployed. As shown in FIG. 1A, a household may include a plurality of display devices, such as high definition, wide aspect ratio television display 172, an analog television display 170, a computer monitor display 120, an additional computer monitor display 121 (the computer display may be analog or digital displays, such as LCD displays), a hi-fi stereo system 171, and source devices 173 and 174 (the source devices may be radios, CD players, DVD players, satellite receiver, cable receiver, laser disc player, VCR, Internet router, etc.). The source devices may include means for establishing a transmission link with any and all of the other tuners for distributing media content, such as a wired connection or a wireless connection. To provide an ideal environment for implementing the present invention, some or all of the tuners are connected, either to each other or to a central device, through a local area network (“LAN”) or a wide area network (“WAN”). Preferable, the home network is a digital network, which can be wired or wireless. Alternatively, the digital network may be effected through power lines.

FIG. 1B schematically illustrates a LAN or WAN enabled home network, in which the presentation devices (e.g., televisions 154, 155 and speakers 156) and the source devices (e.g. DVD player 150 and CD player 151) are connected to the same network 158. Also shown in FIG. 1B are management units 152 and 153, which are preferably included in accordance with the preferred embodiment of the present invention. A management unit may be a computer or any other device that have networking and computer processing capabilities, such as a cable or satellite set top box, or an entertainment unit such as a gaming device. It is noted that the present invention may be implement into one or more of the management units, or within one of the source or reproduction devices, as either software or programmed hardware. Preferably, the home network is protected by encryption (e.g., 3DES encryption) so as to prevent compromise of the system that may result in theft of content.

FIG. 2 illustrates a general overview of a centralized scheduling system in accordance with the preferred embodiment of the present invention. In particular, a user 201 interacts with the system preferably through a graphical user interface (“GUI”) 202, which in accordance with the preferred embodiment is presented to the user on a display device such as a television. Using the GUI, the user 201 may make requests to receive content or a request to schedule the recording of future content (e.g., future broadcast event). In accordance with the preferred embodiment, the user requests are received by a request manager 203, which processes the requests in accordance with the type of request received. If the request received is a “live request,” (e.g., a station request to receive content from particular station, such as a satellite channel station) then the request is preferably forwarded to the scheduling kernel 206, and if satisfied, a station change is submitted to the device manager 205, which effects the retrieval of content from the intended source (e.g., tune the display device to the requested channel station). If the request received is a “recording request”, then the request manager will submit the request to the global scheduler 208, which will determine the time slots that satisfy the request (including by gathering information from the scheduling kernel 206), and then forward those time slots as requests to the scheduling kernel 206 in a manner as described above.

As will be explained in further detail below, the request manager 203 may also access the official schedule of content listings (either periodically or upon certain predetermined events, such as receiving a request from the user 201) to ensure accurate processing of the request. At the same time, the global scheduler may receive updates 207 that may include updates to the hardware configuration of the network, updates to the EPG, etc. Finally, the global scheduler, either on a periodic basis or upon predetermined events, may publish a schedule 209 that lists all of the user's recording requests.

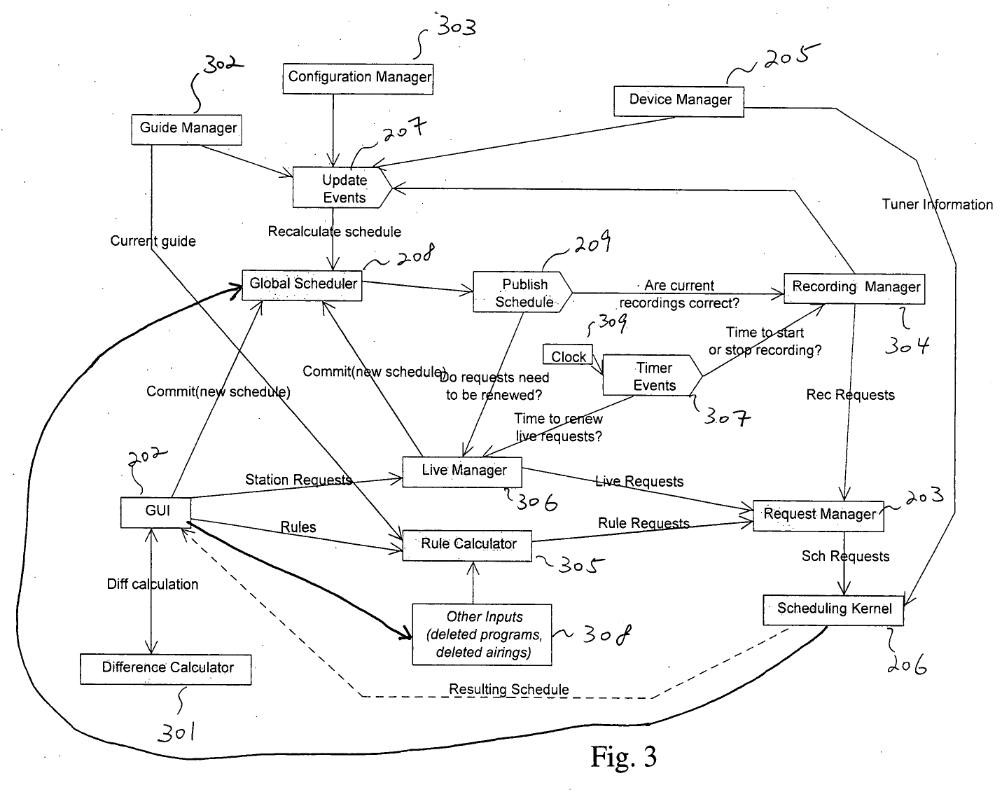

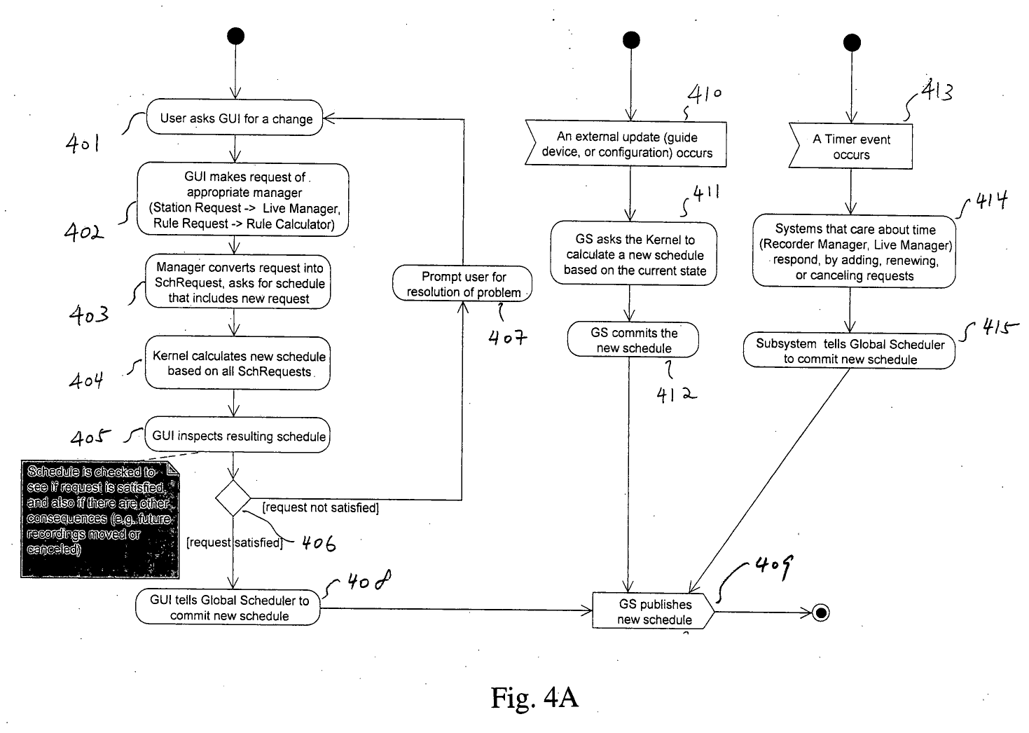

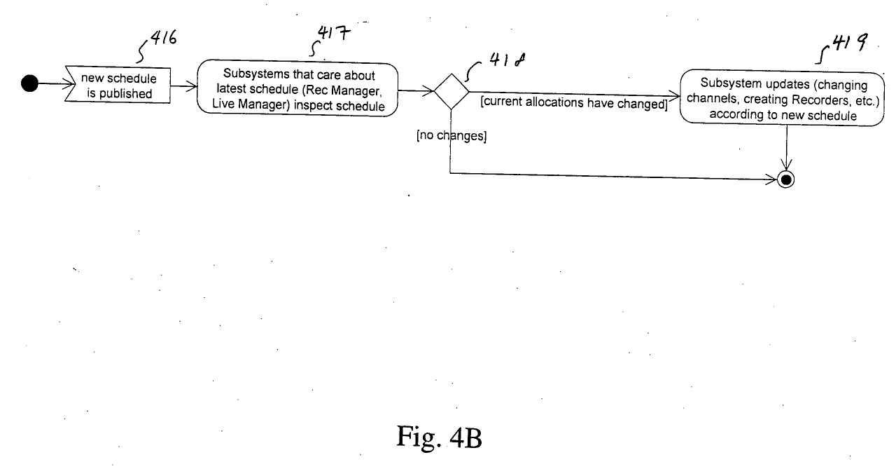

FIG. 3 illustrates further details of the system shown in FIG. 2, while FIGS. 4A and 4B schematically illustrate the logical steps of the shown centralized scheduling system in accordance with the preferred embodiment. As shown in FIGS. 3 and 4A, a user request 401 from the GUI 202 may be one of a rule request (which is a request to set current or future recording events; for instance, a rule request may instruct the system to record all Star Trek episodes, which may be a show that is broadcasted on a particular cable channel during a specific time on a specific day of the week.) or a live request (such as a request for a channel change).

In accordance with the preferred embodiment, upon receiving the user request 401, the GUI 202 forwards the request 402 to the appropriate request manager. In particular, the request is a rule request, the request is preferably forwarded to the rule calculator 305; if the request is a live request, then it is preferably forwarded to the live manager 306. The requests are then processed by the respective calculator/manager, and forwarded to the request manager 203, which converts 403 the requests into a schedule request, which is a request for a new system schedule that would take into consideration the new user request.

The schedule request from the request manager 203 is then forwarded to the scheduling kernel 206, which then calculates 404 a new schedule that takes into consideration the new user request. Once the new schedule is computed, it is preferably communicated to the global scheduler 208 for commitment by the centralized scheduling system. In accordance with the preferred embodiment, before the newly calculated schedule is committed, it may be first displayed 405 to the user 201 via the GUI 202 to prompt the user to confirm the new schedule. At the same time, if the new user request causes irreconcilable conflicts with the existing schedule, such as recording a show at the same time that another show has been previously scheduled to be recorded, then the conflict may be presented 407 to the user 201 for resolution by the user 201.

Besides user requests, other events can cause a new schedule to be calculated. These events may include timer events 307 and update events 207. With respect to timer events, referring back to FIGS. 3 and 4A, a timer event may occur 413. A timer event may be a triggered pre-scheduled event, such as a pre-scheduled recording, or may be an interruptive event, such as a live request that is occurring during a pre-scheduled period of recording. For purposes of the preferred embodiment, a timer event may be any event that is triggered by time or any event that affects pre-scheduled time events. When such a timer event occurs 413, it is preferably sent by a timer events manger 307 (which may be driven by a master clock 309 of the centralized scheduling system) to the appropriate respondent, such as the recording manager 304 or the live manager 306. One type of timer event may be a request to cancel a previously submitted rule request. For instance, a user 201 may decide to cancel a previous rule request to record all Star Trek shows airing on Thursday nights at 8:00 p.m. Alternatively, the system may be configured whereby a user cancels a previously-submitted rule request with a special “cancel” request, which results in the request being added to the set of deleted airings or programs (308) depending on the request.

With respect to update events 207, which may include events such as changes in device configurations or programming guide listing, the events, upon occurrence 410, preferably causes the global scheduler 208 to request 411 the scheduling kernel 206 to update and calculate a revised schedule. As with the other types of events, the revised schedule is committed 412 by the global scheduler and is published 409.

As shown in FIG. 4B, once a new schedule is published 416, any subsystems, such as the live manger and the recording manager, inspects 417 the schedule to determine 418 whether any actions 419 need to be taken. The subsystem inspection may take place via queries by the subsystems to the published schedule.

Details of various components illustrated in FIG. 3 will now be addressed with references to additional drawings discussed below.

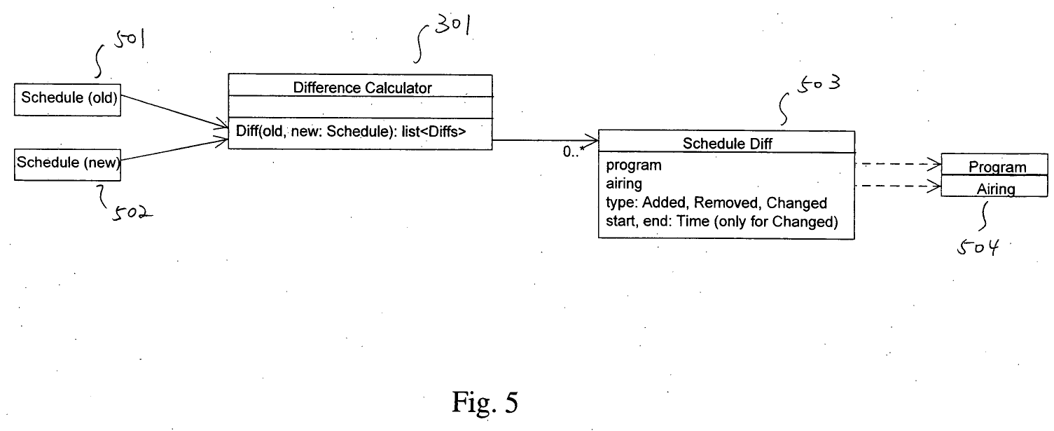

FIG. 5 shows a difference calculator 301 in accordance with a preferred embodiment of the present invention. The primary function of the difference calculator 301 is to calculate the difference between a previously published schedule (i.e., the old schedule) 501 and the newly published schedule (i.e., the new schedule) 502. The difference 503 between the two schedules are identified (e.g., add program recording, remove program recording, change start time of recording, etc.) 504 and returned to the GUI 202 for display to the user 407 and/or forward to the appropriate manager for effecting further actions.

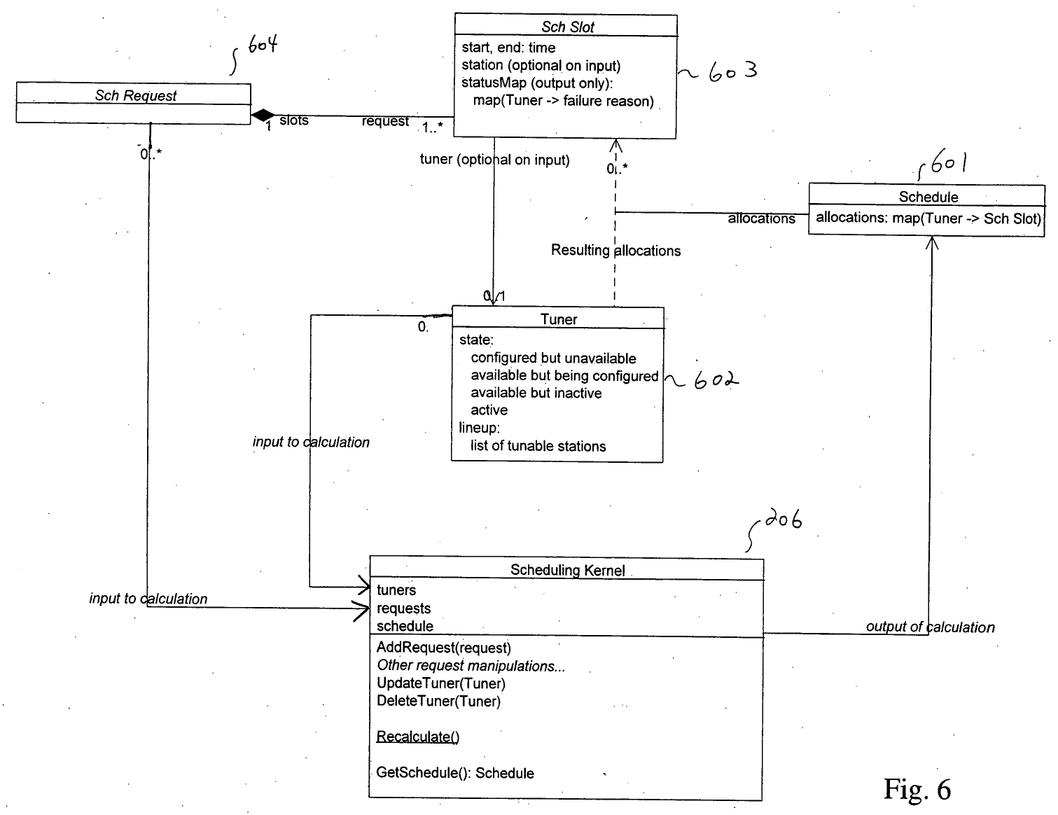

FIG. 6 shows the interactions between the scheduling kernel 206 and the rest of the scheduling system. The scheduling kernel 206 takes as input a series of requests, along with the state of the tuners in the system, to produce a tuner schedule that describes what tuner would be on what channel and why, both in the present timeframe and also in the future. The scheduling kernel 206 is essentially a data processor. Specifically, the scheduling kernel 206 interacts with tuners 602 on the network and, upon receiving requests 604 (such as requests from the global scheduler), calculate/revise schedules.

In accordance with the preferred embodiment, the scheduling kernel 206 is given a list of requests (in order from highest-priority to lowest-priority). Each request includes a list of slots (in order from most-desired to least-desired). A slot specified the begin- and end-time, and the station and/or tuner. A station without a tuner designation may mean “this station on any tuner”, where as a tuner without a station designation may mean “this tuner on whatever station it happens to be on” (used during configuration).

In accordance with the preferred embodiment, the scheduling kernel 206 attempts to produce a schedule satisfying as many requests as possible, given the available system resources (i.e., the number of tuners available that may access the requested content). The kernel 206 “satisfies” a request by scheduling exactly one of its slots in the schedule. After the kernel executes its scheduling algorithm, each slot gets a status of either “OK”, or an error describing why it could not be scheduled. Since the kernel 206 will try to schedule the slot on multiple tuners, there is preferably one status value for each tuner (stored in the slot's “statusMap”). Example of failure values may include (among others) TUNER-NOT-AVAILABLE, TUNER-DOES-NOT-PROVIDE-REQUESTED-STATION, CONFLICT-WITH-HIGHER-PRIORITY-REQUEST, and TUNER-IS-DISABLED.

The result of the schedule calculation is an update to each Sch Request 604, specifying which slot (if any) has been scheduled to satisfy the request, and an update to the slot to specify which tuner (if any) has been scheduled for that slot. The resulting schedule can also be accessed a different way: through the global set of “allocations” (as noted in FIG. 6) which describes, for each tuner, all of the slots scheduled on that tuner. The resulting slots will never conflict (i.e. 8:00-8:30 on HBO, and 8:15-8:16 on SHO), but they may overlap (e.g. 8:00-8:30 on HBO, and 8:15-8:16 on HBO). Slots are also scheduled based on the tuners' lineups what stations are provided by each tuner: a slot that requests station A will never be scheduled on a tuner that does not provide station A.

Finally, the result of a kernel 206 calculation is simply a schedule. There is no guarantee that it will ever be forwarded to the global scheduler. Specifically, a user's request will cause a new schedule to be calculated 404, and only if the resulting schedule is acceptable to the user or the GUI will it be sent to the global scheduler to be committed 408. In other cases, where no user feedback is available (timer events 413, external updates 410), the schedule is assumed to be acceptable, and is automatically committed (412, 415).

In accordance with the preferred embodiment, the scheduling kernel 206 receives, from the various managers, requests that comply with a uniform format, each of which (either live or rule request) asks for a particular station at a particular, bounded time (i.e. with a beginning and an end). For rule requests, the request format may be structured to request a particular station for the period of time.

For live requests, the request format in accordance with the preferred embodiment may be in the form of a series of finite-timed requests for tuning to a particular station, each one of the request asks for the tuner to be tuned to that station for a predetermined period of time (e.g., one minute) (as opposed to, for instance, simply asking for tuning to HBO with no end time indicated). For instance, a live request for HBO may be coded in software as LiveRequest(station: HBO, start-time: <now>, end-time: <now+60 seconds>). The requests are preferably continuously supplied to the scheduling kernel 206 until the user terminates viewing of that channel. In accordance with the preferred embodiment, the live manager 306 is responsible for translating/formatting a user open-ended live request into a series of close-ended tuning request.

One advantage of using a series of closed-ended request for the live requests is the ability to set a maximum time span in which the user can be warned about recording conflicts. For instance, if (in a one-tuner system) there is a recording scheduled for 9:00 on ESPN, and a user tunes to HBO at 8:55, there is no warning at the time of tuning. But once the time passes 8:59, the schedule recalculation will reveal the conflict between the two requests, and the system can ask the user how he wants to resolve the problem. In the above example, the live manager preferably renews the series of closed-ended live requests before the previous closed-ended request expires. Rather, the system may, for instance, renew the requests every fifteen seconds. This would allow the system sufficient time to detect and communicate to the user as to an upcoming conflict; that is, referring to the above example, if the system waited until the request was over to renew the request, the user may not detect the conflict until literally a second before the recording started.

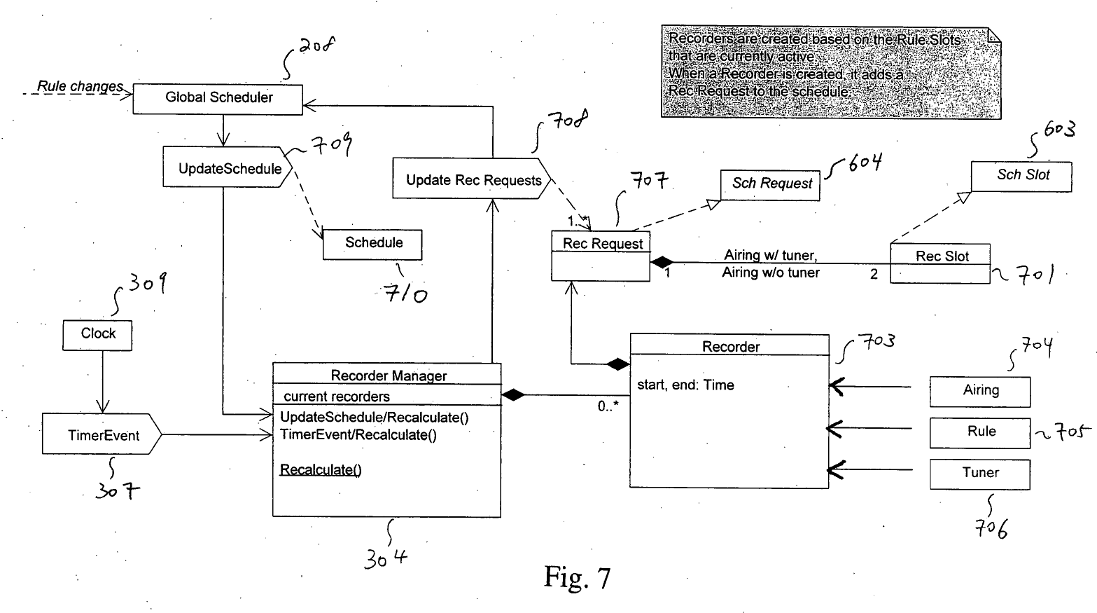

FIG. 7 illustrates the recording manager 304 and its interaction with the various components of the centralized scheduling system. The recorder manager 304 responds to timer events 307 by generating recorder 703 to effect the scheduling of recordings. A recorder 703 is preferably a data structure created for each recording event to take place. Once the recorder 703 is created, it initiates actions within the centralized scheduling system via a recording request 707 that causes a program to be recorded. The actions may include instructing a tuner to tune to a particular source of content (or instruct the tuner to not change its current tuned source). The actions may be effected via a variety of instructions to the tuners, including instructions that may emulate simple remote control signals for changing a station. In order to properly instruct the various components of the centralized scheduling system, the recorder 703 preferably receives information regarding airing 704, rules 705, and tuner 706.

In accordance with the preferred embodiment, the recorder manager 304 generates one recorder 703 for each currently-scheduled recording. The recording is fully specified by the information about what airing to record 704, what tuner to use to record 706, and what rule resulted in the recording 705. The rule was the user recording request (see FIG. 3., arrow from 202 to 305), the airing is a data structure that comes from the guide manager 302, and the particular airing 1103 and tuner 602 are part of the Schedule 601 produced by the scheduling kernel 206.

In accordance with the preferred embodiment, a recording slot 701 is created by the recorder 703 and is formatted for incorporation into the global schedule as a schedule slot 603. The recording slot 701 is preferably treated by the centralized scheduling system as a high-priority schedule item. Accordingly, if there should exist a conflict between the recording slot 701 and a low-priority type request, such as a live request, the recording slot will be prioritized over the low-priority requests. However, in accordance with the preferred embodiment, a user of the centralized scheduling system may have an option to trump over the priority of the recording request; for instance, if a user enters a live request that conflicts with a scheduled recording slot, the user may be given the option to override the previously programmed recording slot.

It should also be noted that the recorder manager 304 may also receive input from the global scheduler 208 via any updates 709 to the published schedule 710. Should the updated schedule affect a previously programmed recording request 707, the recorder manager may generate a update recording request 708 to edit the previously programmed recording request 707, which will in turn cause the generation of revised recorder and schedule slots.

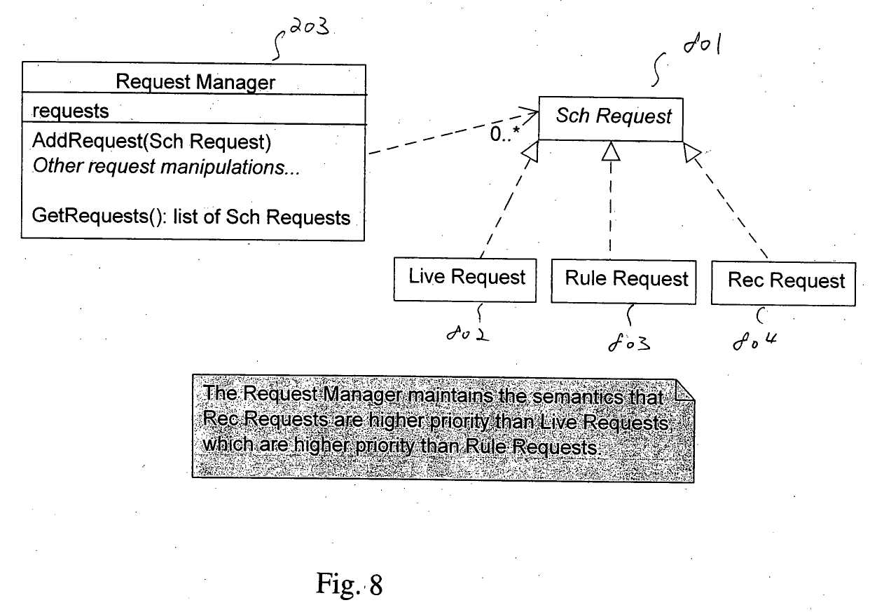

FIG. 8 illustrates the interaction of the request manager 203 and the various requests received (i.e., live request 802, rule request 803, and recording request 804). The requests are processed and forwarded as a schedule request 801 to the scheduling kernel. In accordance with the preferred embodiment, the request manager prioritizes the requests such that the recording requests are high priority than live requests, which are higher in priority than the rule requests. Again, if conflicts exist between ongoing requests, the request manager preferably prioritizes the requests, and may notify the user 201 via the GUI 202 of the conflict and prioritization.

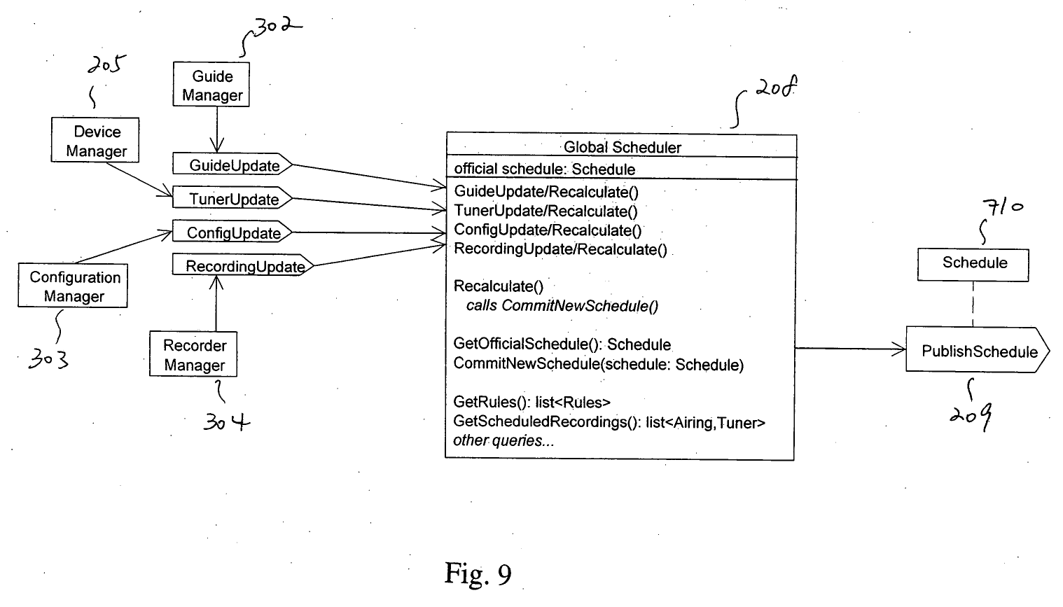

FIG. 9 illustrates detail of the global scheduler 208 and its interaction with the various components of the scheduling system of the preferred embodiment. The global scheduler 208 is responsible for publishing 209 the schedule 710 generated by the scheduling kernel 206. The published schedule is used for generating a programming guide user interface that allows the user to access/edit the various recording requests or to effect live requests. The global scheduler 208 is also responsible for storing the published schedule in a memory so that, should the system be shut down or restarted, the published schedule is not lost.

When a new schedule is published, either because of a new event caused by the user (e.g., configuration update or a recording update) or by the system (e.g., a programming guide update or a tuner update), the various components of the centralized scheduling system inspects the published schedule and carry out new commands (if any) accordingly. In accordance with the preferred embodiment, the global scheduler 208 also detects changes to the state of the system, such as when a new tuner is connected or when a tuner is disconnected. When system changes occur, the global scheduler 208 causes the scheduling kernel 206 to recalculate a new schedule to determine whether any changes need to be made to the published schedule. For instance, if a tuner that was programmed to record a programming became disconnected, or otherwise occupied by a user override (such as a override live request) when the recording was supposed to begin, then the global scheduler 208 will cause the scheduling kernel to generate alternative schedule slots in an effort to satisfy all of the pre-existing recording requests.

It should be noted that, in an alternative embodiment of the present invention, like many of the software modules discussed above, the global scheduler 208 and the kernel 206 may be embodied as one single software module or hardware realization of the same.

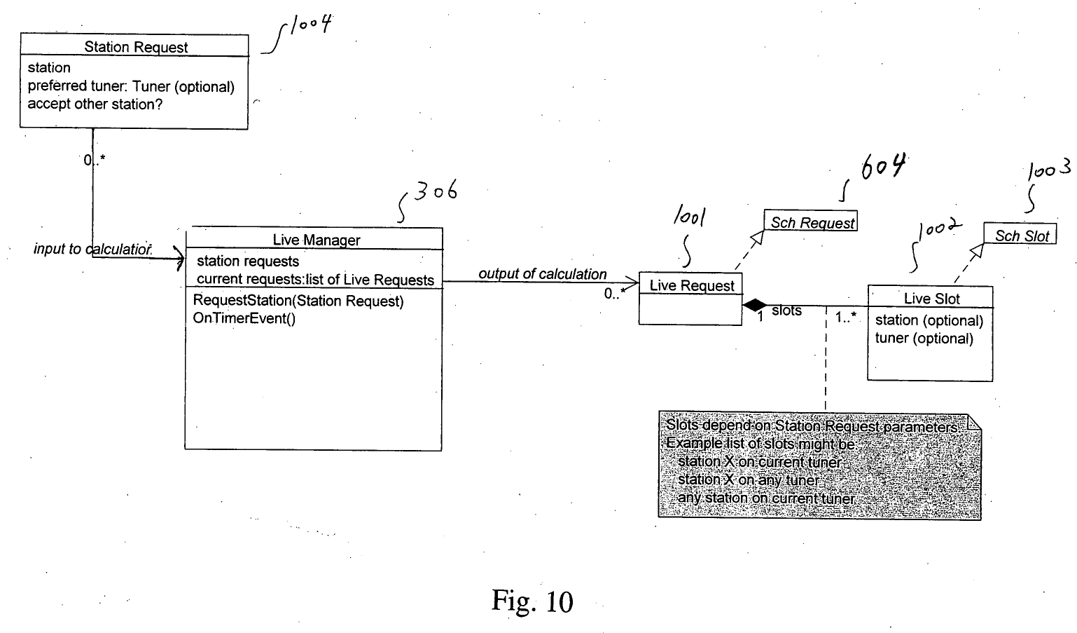

FIG. 10 illustrates live manager 306. As shown in FIG. 10, station requests 1004 from a user is forwarded to the live manager 306 for processing. In accordance with the preferred embodiment, the live manager inspects the tuners on the system to determine which of the tuners are capable of satisfying the station request, and outputs a live request 1001 that will effect the tuning requested. As discussed above with respect to FIG. 5, the live request 1001 may be a series of close-ended schedule requests 604 to the scheduling kernel 206.

In accordance with an alternative embodiment of the present invention, a live request will be reflected on the global schedule to indicate that a particular tuner is tuned to a particular station; this is effected via the generation of a live slot 1002, which will be inserted as a schedule slot 1003 into the global schedule. In accordance with another alternative embodiment, the user may express a preference for a particular tuner in the station request 1004. If the user does not specify a preferred tuner, the live manager 306 may make select a tuner based on tuner capabilities vs. the presentation device. For instance, if the station request is made for viewing a program on a high definition television, and if there is more than one tuner available to tune to that program where one can tune to the high definition version of the program whereas the other can only tune to a standard definition of the program, the live manager 306 will select the high definition tuner to execute the station request.

In accordance with the preferred embodiment, if the live manager 306 receives a station request 1004 without a preferred tuner, then, upon allocation of a tuner by the global scheduler 208, it may update the request so that the preferred tuner is now the allocated tuner. This mechanism causes the desired behavior that a station request will preferentially be fulfilled by the same tuner over time, rather than switching tuners as live requests 1001 are periodically re-issued.

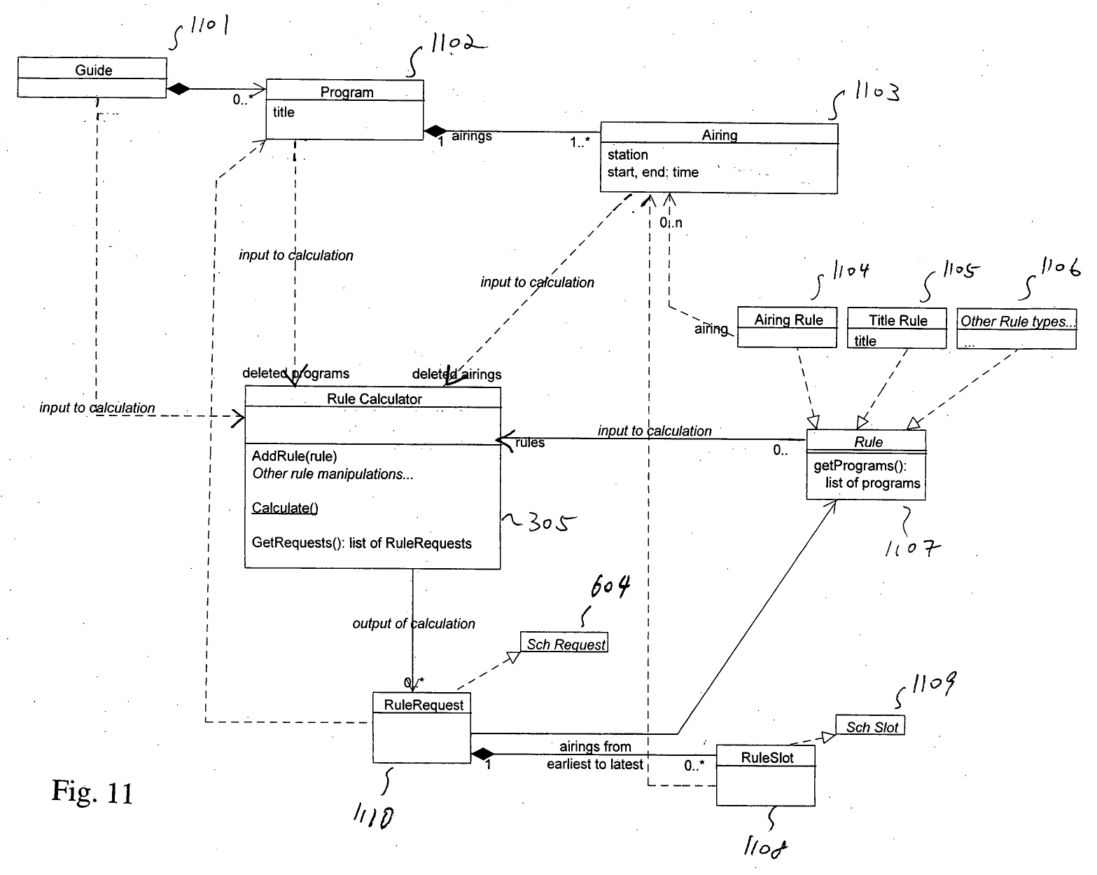

FIG. 11 illustrates the rule calculator 305 and its interactions with the various components of the centralized scheduling system. The rule calculator 305 is responsible for translating a rule 1107, such as “record all Star Trek shows” into a rule request 1110, which is formatted into a schedule request 604 for input to the scheduling kernel 206 (see FIG. 6). The rule 1107 may originate from one of airing rule 1104, title rule 1105, or other rule types 1106. Airing rule 1104 specifies a start and end time for a particular airing station, title rule specifies a program listing 1102 (such as a listing found on the programming guide 1101), and other rule types 1106 may include customized recording requests. For instance, a user may specify a rule whereby all titles of “Star Trek” from a particular station to be recorded on a particular evening of each week.

Once a rule request is generated, a corresponding rule slot 1108 is also created which also causes a schedule slot 1109 to be generated for purposes of inclusion in the published schedule. Again, in accordance with the preferred embodiment, scheduling requests are submitted to the scheduling kernel 206. A scheduling request may contain one or more schedule slots, preferably in an order from most-desired to least-desired. Preferably, only one slot for a given request will be scheduled. At a level higher: a rule is submitted to the rule calculator. The calculator transforms the rule into no request or more rule requests, in order from highest-priority (as specified by the user) to lowest-priority.

Below example may help illustrate the concept described above

Given Rule: “All shows with title Star Trek”

Rule Request: “Record Star Trek episode “Amok Time”

Rule Slot: “Record Star Trek episode “Amok Time” Wed. 8:00 on SCIFI.

In this instance, multiple rules would correspond to multiple user requests for different shows. Multiple requests for a rule would correspond to multiple episodes (“programs”) that match the rule, within the guide timeframe. Multiple slots would match multiple airings (Wed. at 8:00 on SCIFI, Fri. at 2:00 on 44) for a particular episode. Slots are listed from earliest to latest, so that a particular recording will preferably be handled ASAP.

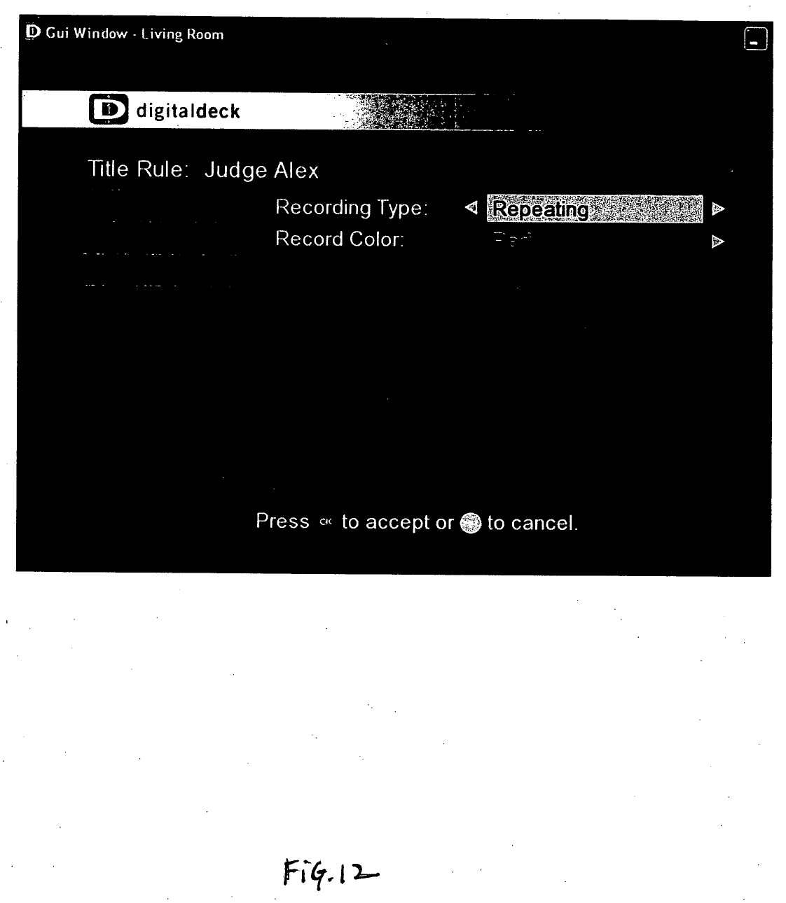

FIGS. 12-16 illustrate some sample images that a user may experience while using the graphical user interface 202.

Specifically, FIG. 12 is an illustration of a screen for scheduling of recording, where a user has entered a title rule for recording the show “Judge Alex.”

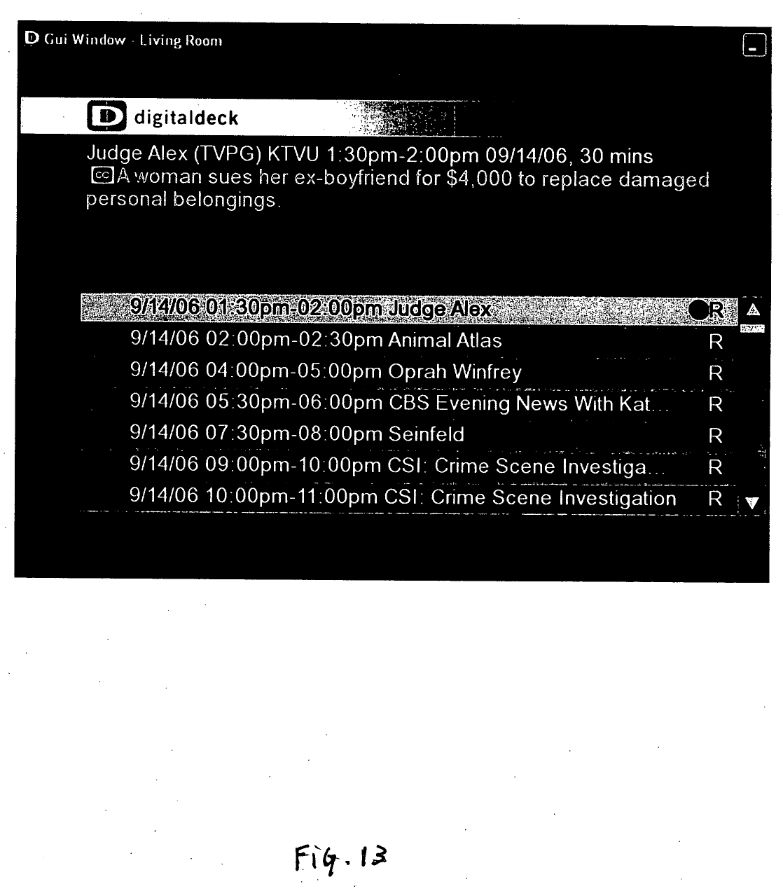

FIG. 13 shows a screen showing a list of scheduled recordings; it is noted that, upon highlighted of a scheduled recording, a brief description of the scheduled show is shown on the screen. The user may scroll up or down the list of scheduled recordings. The status indicator of “R” next to a recording button indicates that the recording is the result of a title (“repeating”) rule.

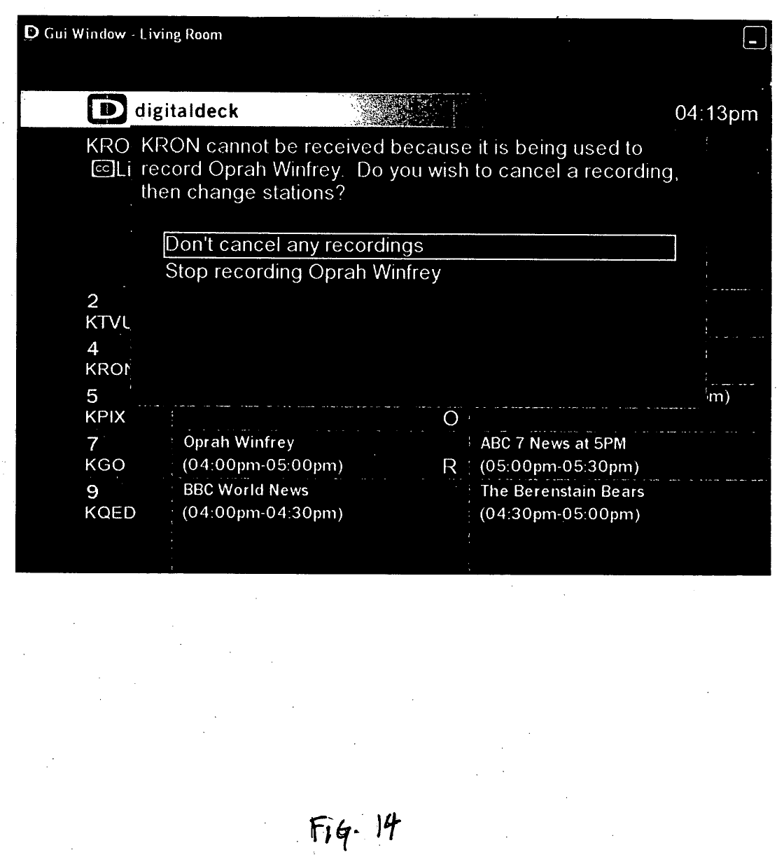

FIG. 14 illustrates a screen prompting a user to resolve a conflict in the centralized scheduling system. As indicated on the screen, a user request to receive (via a live request) for the station KRON could not be satisfied because of the limited resource available on the system. Specifically, a tuner that is otherwise capable of tuning to the station is occupied for recording the “Oprah Winfrey” show. A user is prompted to decide whether the recording, which otherwise has priority over a live request, should be canceled.

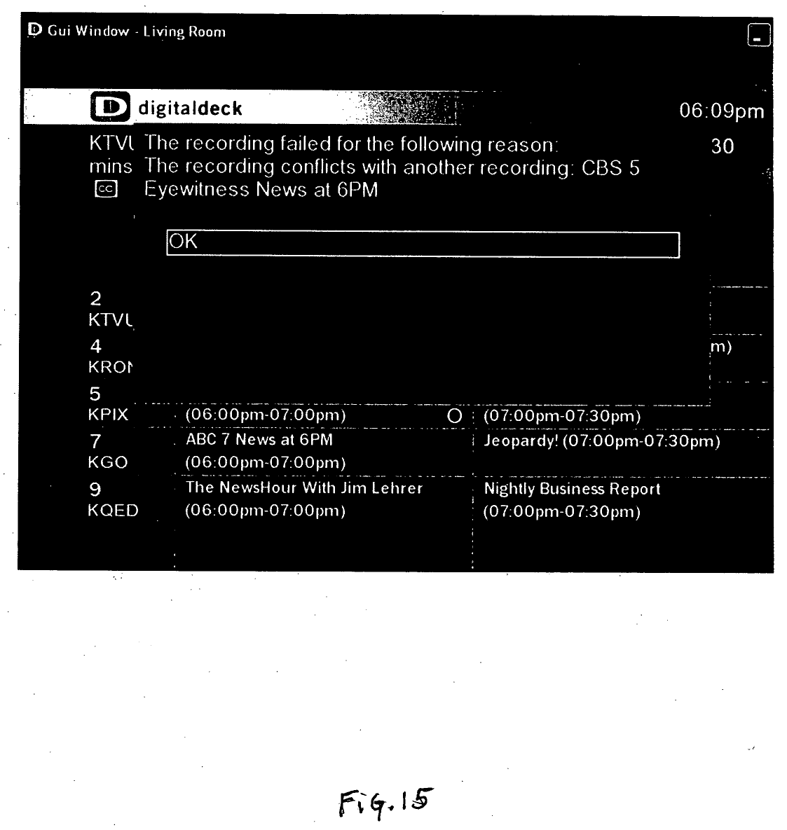

FIG. 15 illustrates another prompt to the user informing a failed attempt to record a show that would cause a conflict within the system for the recording of another show.

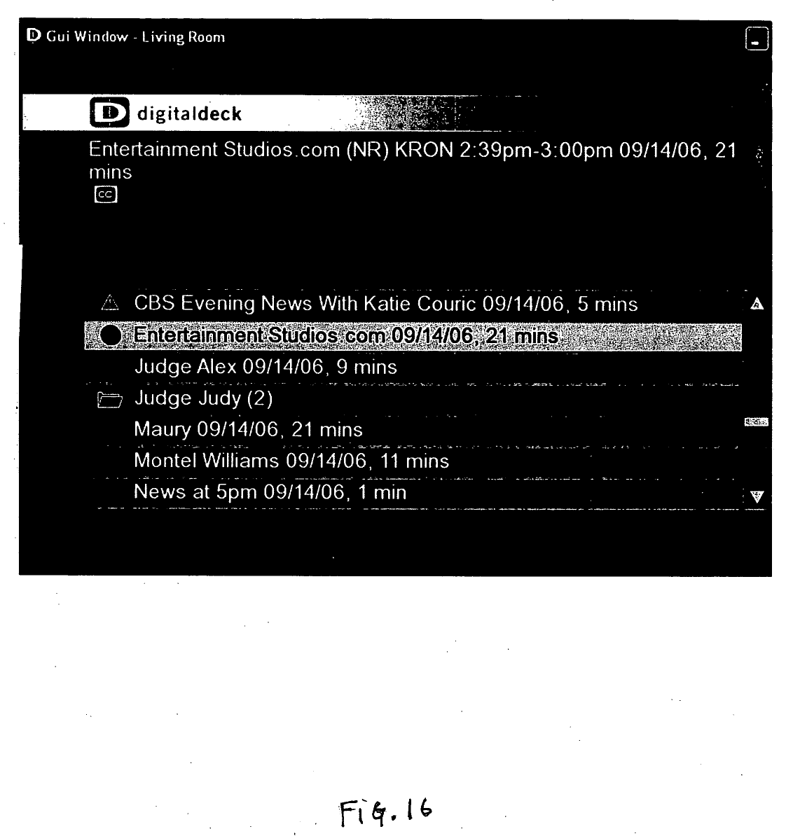

FIG. 16 illustrates a video guide that indicates a list of shows scheduled to be recorded (or, recordings that have already taken place), where status indicators besides the listings inform the user of any special circumstances that may exist for that recording. For instance, a status indicator of an “attention!” icon next to the show listing of “CBS Evening News with Katie Couric” may indicate that a recording is about to begin (in five minutes) (or, in the instance where recording was supposed to take place, that something went wrong and the show was not recorded). A folder icon next to the listing of “Judge Judy,” with a parenthetical of “(2)” next to the listing may indicate that the request is a rule request, and that under the rule, two shows of the “Judge Judy” are scheduled to be recorded (or, alternatively, two shows that have already been recorded). The screen also shows, for the programs already recorded, bookmarks indicating that the program has already been played back and where the playback may have stopped (e.g., the “9 mins”, “21 mins” indicate how far the bookmark is in the show—if the user were to watch again, they could start from that point.)

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

What we claim:

1. A centralized multi-source content management apparatus for managing viewing, recording, and playback of content, said device operatively connectable to a plurality of tuners and a plurality of presentation devices over a network, said multi-source content management apparatus comprising:
a system status detecting section, said system status detecting section monitors the status of the tuners and the presentation devices connected to the network;
a programming guide receiving section, said programming guide receiving section receives programming guide indicating availability of programming content;
a user interface section, said user interface section capable of generating a graphical user interface to be displayed on at least one of the presentation devices;
a request manager section, said request manager section capable of processing user requests for a live request or a recording request, said user requests received from the graphical user interface;
a scheduling kernel section, said scheduling calculating section generate a schedule of content management based on user requests received by the request manager section; and
a global scheduling section, said global scheduling section publishes a global schedule for access by each of the presentation devices, said global schedule include the generated schedule of content management.

2. The apparatus of claim 1, further comprising an internal tuner.

3. The apparatus of claim 1, wherein the network is a wireless network.

4. The apparatus of claim 1, further comprising a device manager section, said device manager section receives content requests for retrieving content from a specified tuner, and causes the specified tuner to retrieve the requested content.

5. The apparatus of claim 4, wherein the device manager section receives content requests from one of the request manager section and the schedule kernel section.

6. The apparatus of claim 1, wherein the graphical user interface generated by the user interface section may be used by the user to access a programming guide.

7. The apparatus of claim 1, wherein the graphical user interface generated by the user interface section may be used by the user to access the global schedule.

8. The apparatus of claim 1, further comprising a rule calculator section, the rule calculator section receives user request for repeated recording events.

9. The apparatus of claim 1, wherein the user request is one of a live request, recording request, and a rule request.

10. The apparatus of claim 1, further comprising a difference calculator, said difference calculator calculating a difference between a pre-existing global schedule and a newly calculated schedule of content management, said newly calculated schedule of content management begin generated by the scheduling kernel section after the publication of the pre-existing global schedule.

11. A program, embodied on a computer-readable medium of a content management apparatus connected to a network of a plurality of tuners and a plurality of presentation devices for causing the apparatus to execute a method of content management, said method comprising the steps of:
determining status of each tuner connected to the network;
receive at least one programming guide, said programming guide indicating content available for retrieval by one or more of the tuners;
generating a graphical user interface for presentation on at least one of the presentation devices, said graphical user interface including said at least one programming guide;
receive a user request from the graphical user interface, said user request being one of a live request for content, rule request for repeated recording of a scheduled program, or a single recording request of a currently available program;
selecting a tuner for satisfying the user request;
generate a global schedule, said global schedule including said at least one programming guide and an event indicating one of a present and a future satisfaction of the user request; and
presenting the global schedule to the user on one of the presentation devices.

12. The program of claim 11, wherein the content management apparatus includes a request manager, said method further comprises the step of routing the user request to the request manager.

13. The program of claim 11, wherein the network is a wireless network.

14. The program of claim 11, wherein the method further comprises the step of, if the user request is a live request, translating the live request into a series of finite time request to tune to a content source for a fixed period of time.

15. The program of claim 11, wherein the method further comprises the step of determining whether satisfaction of the user request may be possible given the resources of the tuners on the networks, and if not, presenting an error message in the graphical user interface.
